(19) United States
(12) Patent Application Publication
(10) Pub. No.: US 2009/0262801 A1
(43) Pub. Date: Oct. 22, 2009

(54) DEAD ZONE PARAMETER SELECTIONS FOR RATE CONTROL IN VIDEO CODING

(75) Inventors: Peisong Chen, San Diego, CA (US); Phanikumar Bhamidipati, San Diegon, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/104,961

(22) Filed: Apr. 17, 2008

(51) Int. Cl. H04N 7/26

(52) U.S. Cl. 375/240.03; 375/E07.14

(57) ABSTRACT

Quantization techniques are used in video coding to quantize residual coefficients. So-called “dead zone parameters” are selected in the quantization process of residual coefficients of residual video blocks. The dead zone refers to a region of magnitude for coefficients below which any coefficient will be quantized to zero. A method and apparatus of quantizing coefficient values of video blocks in a video coding scheme is provided. A quantization parameter is selected for a set of video blocks. Dead zone parameters are then selected for different video blocks in the set of video blocks. Next, the quantization parameter and the dead zone parameters are applied to quantize the coefficient values of each of the video blocks.

### TECHNICAL FIELD

This disclosure relates to digital video coding and, more particularly, quantization techniques used in video coding to control and adjust the video coding rate.

### BACKGROUND

Digital video capabilities can be incorporated into a wide range of devices, including digital televisions, digital direct broadcast systems, wireless communication devices, wireless broadcast systems, personal digital assistants (PDAs), laptop or desktop computers, digital cameras, digital recording devices, video gaming devices, video game consoles, cellular or satellite radio telephones, and the like. Digital video devices implement video compression techniques, such as MPEG-2, MPEG-4, or H.264/MPEG-4, Part 10, commonly called Advanced Video Coding (AVC), to transmit and receive digital video more efficiently. Video compression techniques perform spatial and temporal prediction to reduce or remove redundancy inherent in video sequences.

In video coding, video compression often includes spatial prediction, motion estimation and motion compensation. Intra-coding relies on spatial prediction to reduce or remove spatial redundancy between video blocks within a given video frame. Inter-coding also relies on temporal prediction to reduce or remove temporal redundancy between video blocks of successive video frames of a video sequence. For inter-coding, a video encoder performs motion estimation to track the movement of matching video blocks between two or more adjacent frames. Motion estimation generates motion vectors, which indicate the displacement of video blocks relative to corresponding prediction video blocks in one or more reference frames. Motion compensation uses the motion vectors to locate and generate the prediction video blocks from a reference frame. After motion compensation, a block of residual information is formed by subtracting the prediction video block from the original video block to be coded. The residual information quantifies the differences between the prediction video block and the video block being coded so that upon identifying the prediction video block and the residual information, the coded video block can be reconstructed at the decoder.

The video encoder may apply transform, quantization and transform coefficient coding processes to further reduce the bit rate associated with communication of the block of residual information. Transform techniques, for example, may rely on discrete cosine transformations (DCTs) to change pixel values to DCT coefficients. Quantization techniques may select and apply a quantization parameter to quantize the coefficients at a desired level of detail. Coefficient coding may involve application of variable length coding (VLC) tables, or the like, to further compress residual coefficients produced by the transform and quantization operations.

Rate control is a major concern for video coding. In video coding, rate control refers to control over the number of bits that are used to code video content, e.g., the number of bits per second. Rate control techniques may be applied, for example, to ensure that video content is coded at a substantially constant bit rate, or to achieve a relatively constant balance of rate and distortion. As the video content changes, the video coding may change to ensure that video content is coded at a particular coding rate commensurate with available bandwidth for communicating the coded video content to other devices.

The quantization process is often used to provide for rate control. The quantization parameters, for example, may be selected for video blocks to ensure that (regardless of the video content being coded), the video content is coded at an acceptable rate. In some cases, the quantization parameters may be selected to achieve a relatively constant balance of rate and distortion. In this case, the rate control can achieve a desired balance between relatively constant rate and relatively constant quality.

### SUMMARY

In general, this disclosure describes quantization techniques used in video coding to quantize residual coefficients. The techniques allow for fine control over the coding rate. Specifically, the techniques may allow for finer control over the coding rate than can be achieved solely through adjustment of a quantization parameter (QP). This disclosure proposes the selection of so-called “dead zone parameters” for video blocks of residual coefficients. In effect, rate control over the coding rate, according to the techniques described herein, can be achieved at sub-QP levels.

In one example, this disclosure provides a method of quantizing coefficient values of video blocks in a video coding scheme comprising selecting a quantization parameter for a set of video blocks, selecting dead zone parameters for different video blocks in the set of video blocks, and applying the quantization parameter and the dead zone parameters to quantize the coefficient values of each of the video blocks.

In another example, this disclosure provides an apparatus comprising a quantization unit that quantizes coefficient values of video blocks in a video coding scheme. The quantization unit includes a quantization parameter module that selects a quantization parameter for a set of video blocks, a dead zone parameter module that selects dead zone parameters for different video blocks in the set of video blocks, and a quantization module that applies the quantization parameter and the dead zone parameters to quantize the coefficient values of each of the video blocks.

In another example, this disclosure provides a device that quantizes coefficient values of video blocks in a video coding scheme, the device comprising means for selecting a quantization parameter for a set of video blocks, means for selecting dead zone parameters for different video blocks in the set of video blocks, and means for applying the quantization parameter and the dead zone parameters to quantize the coefficient values of each of the video blocks.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium and loaded and executed in the processor.

Accordingly, this disclosure also contemplates a computer-readable medium comprising instructions that upon execution in a processor cause the processor to select a quantization parameter for a set of video blocks, select dead zone parameters for different video blocks in the set of video blocks, and apply the quantization parameter and the dead zone parameters to quantize coefficient values of each of the video blocks.

In some cases, the computer-readable medium may form part of a computer program product, which may be sold to manufacturers and/or used in a video coding device. The computer program product may include the computer-readable medium, and in some cases, may also include packaging materials.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is an exemplary block diagram illustrating a video encoding and decoding system.

FIG. 2 is a block diagram illustrating an example of a video encoder consistent with this disclosure.

FIG. 3 is a block diagram illustrating an example of a video decoder consistent with this disclosure.

FIG. 4 is an exemplary block diagram illustrating a quantization unit of a video encoder consistent with this disclosure.

FIG. 5A is a flow diagram illustrating techniques for quantizing coefficient values of video blocks in a video coding scheme.

FIG. 5B is a functional block diagram corresponding to the flow diagram of FIG. 5A.

FIG. 6 is a flow diagram illustrating techniques for quantizing coefficient values of video blocks in a video coding scheme.

FIG. 7 is a flow diagram illustrating techniques for quantizing coefficient values of video blocks in a video coding scheme.

FIG. 8 is an illustration showing a zig-zag scanning order for a 4 by 4 video block that includes 16 coefficients.

### DETAILED DESCRIPTION

This disclosure describes quantization techniques used in video coding to quantize residual coefficients in a video coding scheme. Residual coefficients are an example of coefficients that are common in predictive-based video coding, such as temporally predictive or spatially predictive video coding. In predictive-based video coding, frames or slices of video information are partitioned into blocks of data, and the blocks of data are compared to other blocks of data in other frames or slices of a video sequence (for temporal prediction) or compared to blocks of data within the same frame or slice (for spatial prediction).

Upon identifying a prediction video block that closely matches the video block to be coded, the prediction video block is subtracted from the video block to be coded in order to generate residual information. The residual information quantifies the differences between the prediction video block and the video block being coded. The residual information may comprise a block of residual coefficients, where each residual coefficient quantifies the difference between a given coefficient of the video block being coded and the corresponding coefficient of the prediction video block used. A video block is coded via the residual information, and a vector (for temporal prediction) or a spatial prediction identifier (for spatial prediction) that identifies the prediction video block is used to generate the residual information. By communicating the residual information and the vector or the spatial prediction identifier that identifies the prediction video block, the coded video block can be reconstructed at a video decoder.

The residual information is typically transformed from a pixel domain to a transform domain, e.g., using discrete cosine transformation (DCT). The residual coefficients are then typically quantized. The quantization process is often used to provide rate control in the video coding scheme. The quantization parameters (QPs), for example, may be selected for video blocks to ensure that the video content is coded at an acceptable rate. In some cases, the QPs may be selected to achieve a relatively constant balance of rate and distortion. In this case, the rate control can achieve a desired balance between relatively constant encoding bit rate and relatively constant quality.

The dead zone refers to a region of magnitude for coefficients below which any coefficient will be quantized to zero. That is to say, if a coefficient magnitude of a given coefficient is in the dead zone, quantization of that given coefficient will result in a value of zero. As described in greater detail below, the dead zone may be defined by both the QP defined for the video coding and also a so-called dead zone parameter.

The techniques of this disclosure may allow for finer control over the coding rate than can be achieved solely through adjustment of a QP. To do so, this disclosure provides the selection of so-called “dead zone parameters” for video blocks of residual coefficients. The dead zone parameter (f) is a parameter that, together with the QP, defines the dead zone. The dead zone refers to a region of magnitude for the coefficients below which any coefficient will be quantized to zero. According to the techniques of this disclosure, QPs are selected for a set of video blocks, and dead zone parameters are selected individually for each of the video blocks in the set. This allows more control over the quantization than can be achieved with QPs selection alone. In some cases, different dead zone parameters can be used for different sets of coefficients within a given block. For example, high frequency coefficients of a video block may be quantized using a different dead zone parameter than that used for low frequency coefficients in order to give the high frequency coefficients of a given video block less importance relative to the low frequency coefficients.

Quantization generally refers to a process in which magnitudes of coefficients are reduced in order to achieve compression of a set of coefficients. In quantization, coefficient values may be reduced based on a so called quantization parameter (QP), which defines the quantization step size to be applied in the quantization process. In general, a QP may be selected by a video encoder based on a level of compression desired in a given situation. Larger QPs generally map to larger quantization step sizes, which leads to more quantization, and therefore, more compression. Smaller QPs map to smaller quantization step sizes, which leads to less quantization and therefore, less compression. The relationship between QPs and the quantization step sizes may be defined by the video compression standard.

The basic formula for quantization may be expressed as

$$Z = ⌊ \frac{\vert W \vert + f}{Q} ⌋ ,$$

where Z represents a quantized value (e.g., a magnitude), W represents a coefficient value (e.g., a magnitude) prior to quantization, Q represents the quantization step size corresponding to the quantization parameter, f represents a dead zone parameter and [symbol] is an operand to round to a nearest “less than or equal to” integer. An inequality of f<Q may be presumed.

By changing the quantization step size applied by a quantization unit, the dynamic range of coefficients can be uniformly reduced. The quantization step size, however, is typically pre-defined according to a video coding standard. In ITU H.264, for example, a total of 52 values of quantization step size are supported, indexed by a quantization parameter (referred to herein as “QP”). By selecting a QP (i.e., selecting an index value) the quantization step size is defined as the quantization step size defined for that index value, e.g., as defined by the video coding standard being used.

Coefficients with a magnitude in the region from 0 to Q−f are typically quantized to 0. This region is the dead-zone. In typical ITU H.264 applications, f=Q/6 may be used for Inter macroblocks (MBs), in which case the corresponding dead-zone is 5Q/6. For intra MBs, f=Q/3 is common. In any case, by selecting and/or changing the dead-zone on a video block or sub-video block level, as described herein, one can select or change the number of non-zero coefficients of a video block, and thereby affect the bit rate and provide a mechanism for rate controlled video coding.

In other words, this disclosure recognizes that since the level of quantization is based on both the quantization step size (Q) and the dead zone parameter (f), both of these values may be used to affect the level of quantization. According to this disclosure, the QP (and therefore Q) may be defined for a set of video blocks, but the dead zone parameter (f) may be adjusted on a block-by-block basis. This can achieve an improved level of control over the amount of quantization (and therefore, compression) on individual blocks.

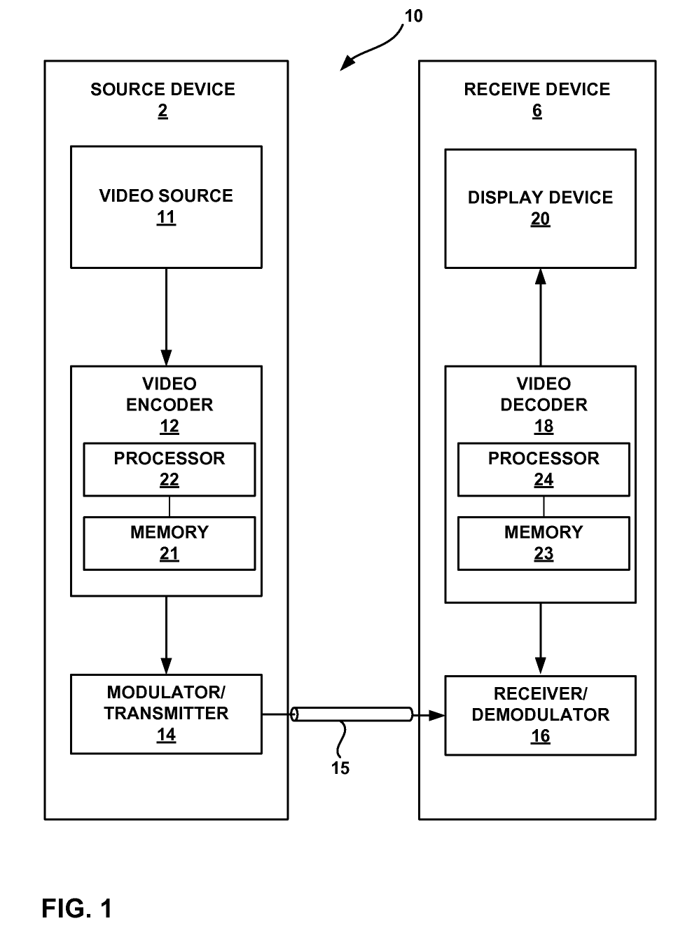

FIG. 1 is a block diagram illustrating a video encoding and decoding system 10. As shown in FIG. 1, system 10 includes a source device 2 that transmits encoded video to a receive device 6 via a communication channel 15. Source device 2 may include a video source 11, video encoder 12 and a modulator/transmitter 14. Receive device 6 may include a receiver/demodulator 16, video decoder 18, and display device 20. Source device 2 of system 10 may be configured to apply quantization techniques in order to quantize residual coefficients of video blocks, and thereby achieve rate control over the coding rate at sub-QP levels.

In the example of FIG. 1, communication channel 15 may comprise any wireless or wired communication medium, such as a radio frequency (RF) spectrum or one or more physical transmission lines, or any combination of wireless and wired media. Communication channel 15 may form part of a packet-based network, such as a local area network, a wide-area network, or a global network such as the Internet. Communication channel 15 generally represents any suitable communication medium, or collection of different communication media, for transmitting video data from source device 2 to receive device 6.

Source device 2 generates coded video data for transmission to receive device 6. In some cases, however, devices 2, 6 may operate in a substantially symmetrical manner. For example, each of devices 2, 6 may include video encoding and decoding components. Hence, system 10 may support one-way or two-way video transmission between video devices 2, 6, e.g., for video streaming, video broadcasting, or video telephony.

Video source 11 of source device 2 may include a video capture device, such as a video camera, a video archive containing previously captured video, or a video feed from a video content provider. As a further alternative, video source 11 may generate computer graphics-based data as the source video, or a combination of live video and computer-generated video. In some cases, if video source 11 is a video camera, source device 2 and receive device 6 may form so-called camera phones or video phones. In each case, the captured, pre-captured or computer-generated video may be encoded by video encoder 12 for transmission from video source device 2 to video decoder 18 of video receive device 6 via modulator/transmitter 14, communication channel 15 and receiver/demodulator 16. The video encoding process may implement techniques of this disclosure to quantize coefficients in the video coding scheme. Display device 20 displays the decoded video data to a user, and may comprise any of a variety of display devices such as a cathode ray tube, a liquid crystal display (LCD), a plasma display, an organic light emitting diode (OLED) display, or another type of display device.

In some cases, video encoder 12 and video decoder 18 may be configured to support scalable video coding (SVC) for spatial, temporal and/or signal-to-noise ratio (SNR) scalability. In some aspects, video encoder 12 and video decoder 18 may be configured to support fine granularity SNR scalability (FGS) coding for SVC. Encoder 12 and decoder 18 may support various degrees of scalability by supporting encoding, transmission and decoding of a base layer and one or more scalable enhancement layers. For scalable video coding, a base layer carries video data with a baseline level of quality. One or more enhancement layers carry additional data to support higher spatial, temporal and/or SNR levels. The base layer may be transmitted in a manner that is more reliable than the transmission of enhancement layers. For example, the most reliable portions of a modulated signal may be used to transmit the base layer, while less reliable portions of the modulated signal may be used to transmit the enhancement layers.

Video encoder 12 and video decoder 18 may operate according to a video compression standard, such as MPEG-2, MPEG-4, ITU-T H.263, or ITU-T H.264/MPEG-4, Part 10, Advanced Video Coding (AVC). Although not shown in FIG. 1, in some aspects, video encoder 12 and video decoder 18 may each be integrated with an audio encoder and decoder, respectively, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification.

The Joint Video Team (JVT) continues to work on SVC extensions to H.264/MPEG-4 AVC. The specification of an evolving SVC extension is in the form of a Joint Draft (JD). The Joint Scalable Video Model (JSVM) created by the JVT implements tools for use in scalable video, which may be used within system 10 (shown in FIG. 1) for various coding tasks described in this disclosure. Detailed information concerning Fine Granularity SNR Scalability (FGS) coding can be found in the Joint Draft documents, and particularly in Joint Draft 6 (SVC JD6), Thomas Wiegand, Gary Sullivan, Julien Reichel, Heiko Schwarz, and Mathias Wien, “Joint Draft 6: Scalable Video Coding,” JVT-S 201, April 2006, Geneva, and in Joint Draft 9 (SVC JD9), Thomas Wiegand, Gary Sullivan, Julien Reichel, Heiko Schwarz, and Mathias Wien, “Joint Draft 9 of SVC Amendment,” JVT-V 201, January 2007, Marrakech, Morocco.

In some aspects, for video broadcasting, the techniques described in this disclosure may be applied to Enhanced H.264 video coding for delivering real-time video services in terrestrial mobile multimedia multicast (TM3) systems using the Forward Link Only (FLO) Air Interface Specification, “Forward Link Only Air Interface Specification for Terrestrial Mobile Multimedia Multicast,” to be published as Technical Standard TIA-1099 (the “FLO Specification”). That is to say, communication channel 15 may comprise a wireless information channel used to broadcast wireless video information according to the FLO Specification, or the like. The FLO Specification includes examples defining bitstream syntax and semantics and decoding processes suitable for the FLO Air Interface.

Alternatively, video may be broadcasted according to other standards such as DVB-H (digital video broadcast-handheld), ISDB-T (integrated services digital broadcast-terrestrial), or DMB (digital media broadcast). Hence, source device 2 may be a mobile wireless terminal, a video streaming server, or a video broadcast server. However, techniques described in this disclosure are not limited to any particular type of broadcast, multicast, or point-to-point system. In the case of broadcast, source device 2 may broadcast several channels of video data to multiple receive devices, each of which may be similar to receive device 6 of FIG. 1. Thus, although a single receive device 6 is shown in FIG. 1, for video broadcasting, source device 2 would typically broadcast the video content simultaneously to many receive devices.

In other examples, modulator/transmitter 14 communication channel 15, and receiver demodulator 16 may be configured for communication according to any wired or wireless communication system, including one or more of a Ethernet, telephone (e.g., POTS), cable, power-line, and fiber optic systems, and/or a wireless system comprising one or more of a code division multiple access (CDMA or CDMA2000) communication system, a frequency division multiple access (FDMA) system, an orthogonal frequency division multiple (OFDM) access system, a time division multiple access (TDMA) system such as GSM (Global System for Mobile Communication), GPRS (General packet Radio Service), or EDGE (enhanced data GSM environment), a TETRA (Terrestrial Trunked Radio) mobile telephone system, a wideband code division multiple access (WCDMA) system, a high data rate 1xEV-DO (First generation Evolution Data Only) or 1xEV-DO Gold Multicast system, an IEEE 802.11 system, a MediaFLO™ system, a DMB system, a DVB-H system, or another scheme for data communication between two or more devices.

In the example illustration of FIG. 1, video encoder 12 is shown as including a memory 21 coupled to a processor 22. Similarly video decoder 18 is shown as including a memory 23 coupled to a processor 24. Memory 21 and memory 23 may store computer-readable instructions executed by processor 22 and processor 24, respectively, to carry out the techniques described in greater detail below. More generally, however, video encoder 12 and video decoder 18 each may be implemented as one or more microprocessors, digital signal processors (DSPs), application specific integrated circuits (ASICs), field programmable gate arrays (FPGAs), discrete logic, software, hardware, firmware or any combinations thereof. In addition, any type of storage elements may be used to realize aspects of video encoder 12 and video decoder 18 corresponding to memories 21 and 23. Each of video encoder 12 and video decoder 18 may be included in one or more encoders or decoders, either of which may be integrated as part of a combined encoder/decoder (CODEC) in a respective mobile device, subscriber device, broadcast device, server, or the like. In addition, source device 2 and receive device 6 each may include appropriate modulation, demodulation, frequency conversion, filtering, and amplifier components for transmission and reception of encoded video, as applicable, including radio frequency (RF) wireless components and antennas sufficient to support wireless communication. For ease of illustration, however, such components are summarized as being modulator/transmitter 14 of source device 2 and receiver/demodulator 16 of receive device 6 in FIG. 1.

A video sequence includes a series of video frames. Video encoder 12 operates on blocks of pixels (or blocks of transform coefficients) within individual video frames in order to encode the video data. The video blocks may have fixed or varying sizes, and may differ in size according to a specified coding standard. In some cases, each video frame is a coded unit, while, in other cases, each video frame may be divided into a series of slices that form coded units. Each slice may include a series of macroblocks, which may be arranged into sub-blocks. As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components.

Smaller video blocks can provide better resolution, and may be used for locations of a video frame that include higher levels of detail. In general, macroblocks (MBs) and the various sub-blocks may be considered to be video blocks. Thus, MBs may be considered to be video blocks, and if partitioned or sub-partitioned, MBs can themselves be considered to define sets of video blocks. In addition, a slice may be considered to be a set of video blocks, such as a set of MBs and/or sub-blocks. As noted, each slice may be an independently decodable unit of a video frame. If the video frame is the coding unit (rather than a slice), the video frame could also be considered to be a set of video blocks, such as a set of MBs and/or sub-blocks.

Following intra- or inter-based predictive coding, additional coding techniques may be applied to the transmitted bitstream. These additional coding techniques may include transformation techniques (such as the 4×4 or 8×8 integer transform used in H.264/AVC or a discrete cosine transformation DCT), quantization techniques on the transformed coefficients as described herein, and transform coefficient coding (such as variable length coding of the quantized transform coefficients or other entropy coding techniques). Blocks of transformation coefficients may be referred to as video blocks. In other words, the term “video block” refers to a block of video data regardless of the domain of the information. Thus, video blocks can be in a pixel domain or a transformed coefficient domain. The term “coefficient” may refer to data in any domain, e.g., coefficients of pixel data in the pixel domain or coefficients of transformed data in a DCT domain.

This disclosure provides quantization techniques used in video coding to quantize residual coefficients. The techniques allow for fine control over the coding rate. Specifically, the techniques may allow for finer control over the coding rate than can be achieved solely through adjustment of a QP. This disclosure proposes the selection of dead zone parameters for video blocks of residual coefficients. In effect, rate control over the coding rate, according to the techniques described herein, can be achieved at sub-QP levels. Furthermore, in some cases, different dead zone parameters may be used to adjust quantization levels within a particular video block of coefficients. For example, higher frequency coefficients may be quantized using a different dead zone parameter than that used for lower frequency coefficients. In particular, higher frequency coefficients may be quantized using a smaller dead zone parameter than that used for lower frequency coefficients, which results in fewer bits in the quantization of the higher frequency coefficients compared to the quantization of the lower frequency coefficients.

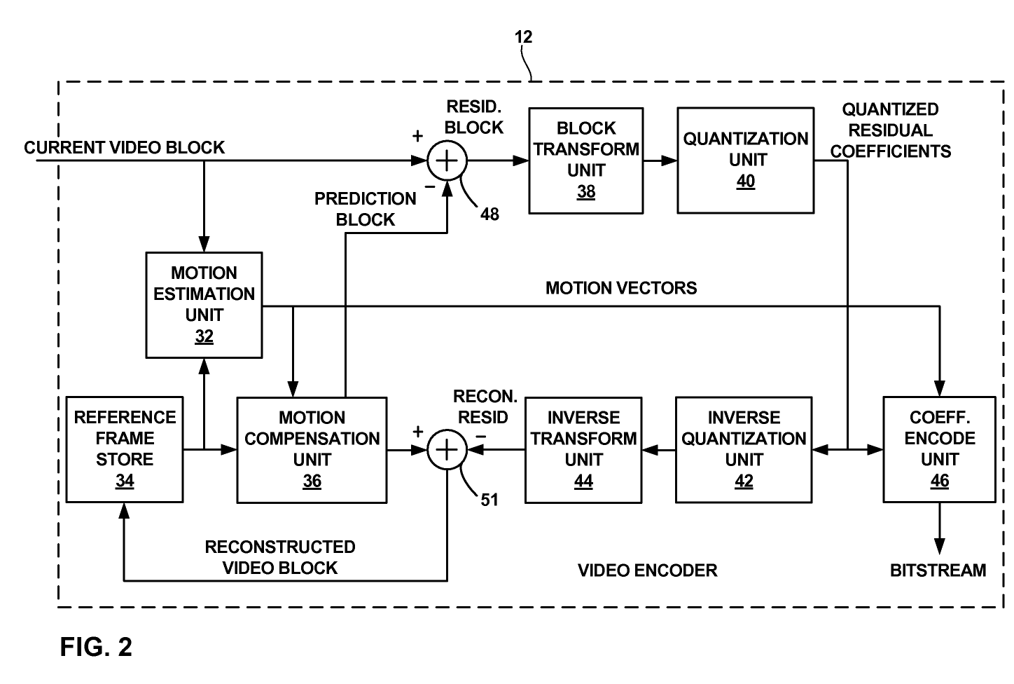

FIG. 2 is a block diagram illustrating an example of a video encoder 12 that may correspond to that of source device 2 of FIG. 1. Video encoder 12 includes a quantization unit 40 to quantize data consistent with this disclosure. Video encoder 12 may perform intra- and inter-coding of blocks within video frames. Intra-coding relies on spatial prediction to reduce or remove spatial redundancy in video within a given video frame. Inter-coding relies on temporal prediction to reduce or remove temporal redundancy in video within adjacent frames of a video sequence. For inter-coding, video encoder 12 performs motion estimation to track the movement of matching video blocks between two or more adjacent frames. For intra-coding, spatial prediction is used to identify other blocks within a frame that closely match the block being coded. In one example, the various components of video encoder 12 of FIG. 2 may correspond to processor 22 and memory 21 of FIG. 1. For example, reference frame store 34 and any temporary storage elements between the different components (which are not shown in FIG. 2 for simplicity) may be implemented as memory 21, and the other illustrated elements of FIG. 2 may be implemented as processor 22 that executes the functions described below. In addition, computer-readable instructions may be stored in memory 21 and executed by processor 22 to carry out the functions described below. As noted, however, many other implementations could be used consistent with this disclosure.

As shown in FIG. 2, video encoder 12 receives a current video block within a video frame to be encoded. In the example of FIG. 2, video encoder 12 includes motion estimation unit 32, reference frame store 34, motion compensation unit 36, block transform unit 38, quantization unit 40, inverse quantization unit 42, inverse transform unit 44 and coefficient encode unit 46. A deblocking filter (not shown) may also be included to filter block boundaries to remove blockiness artifacts. Video encoder 12 also includes summer 48 and summer 51. FIG. 2 illustrates the temporal prediction components of video encoder 12 for inter-coding of video blocks. Although not shown in FIG. 2 for ease of illustration, video encoder 12 also may include spatial prediction components for intra-coding of some video blocks. The quantization techniques of this disclosure can apply with respect to coefficients of any residual blocks, such as blocks that are intra-coded or blocks that are inter-coded.

Motion estimation unit 32 compares a current video block to blocks in one or more adjacent video frames to generate one or more motion vectors. The current video block refers to a video block currently being coded, and may comprise input to video encoder 12. The adjacent frame or frames (which include the video blocks to which the current video block is compared) may be retrieved from reference frame store 34. Reference frame store 34 which may comprise any type of memory or data storage device to store video blocks reconstructed from previously encoded blocks. Motion estimation may be performed for blocks of variable sizes, e.g., 16×16, 16×8, 8×16, 8×8 or smaller block sizes. Motion estimation unit 32 identifies a block in an adjacent frame that most closely matches the current video block, e.g., based on a rate distortion model, and determines a displacement between the blocks. On this basis, motion estimation unit 32 produces a motion vector (MV) (or multiple MV's in the case of bidirectional prediction) that indicates the magnitude and trajectory of the displacement between the current video block and a predictive block used to code the current video block.

As noted above, motion estimation unit 32 identifies a block in an adjacent frame that most closely matches the current video block, e.g., based on a rate distortion model. A rate distortion model generally refers to a model or technique applied by motion estimation unit 32 to balance the amount of data to be used in the encoding versus the amount of distortion that can be tolerated. In this context, the term “rate” is used since the amount of data defined in the encoding can affect the data rate necessary to transfer coded information. The term “distortion” is used since the amount of data defined in the encoding also affects the level of distortion that may be introduced. Rate distortion models are commonly used to balance encoding quality and the amount of data used to achieve the encoding quality.

Motion vectors may have half- or quarter-pixel precision, or even finer precision, allowing video encoder 12 to track motion with higher precision than integer pixel locations and obtain a better prediction block. When motion vectors with fractional pixel values are used, interpolation operations are carried out in motion compensation unit 36. Motion estimation unit 32 may identify the best motion vector for a video block using a rate-distortion model. Using the resulting motion vector, motion compensation unit 36 forms a prediction video block by motion compensation.

Video encoder 12 forms a residual video block by subtracting the prediction video block produced by motion compensation unit 36 from the original, current video block at summer 48. Block transform unit 38 applies a transform, such as a discrete cosine transform (DCT), to the residual block, producing residual transform block coefficients. Quantization unit 40 quantizes the residual transform block coefficients to further reduce the bit rate. More specifically, as described in greater detail below, quantization unit 40 may include a quantization parameter module that selects a quantization parameter for a set of video blocks, a dead zone parameter module that selects dead zone parameters for different video blocks in the set of video blocks, and a quantization module that applies the quantization parameter and the dead zone parameters to quantize the coefficient values of each of the video blocks.

Spatial prediction coding operates very similar to temporal prediction coding. However, whereas temporal prediction coding relies on blocks of adjacent frames (or other coded units) to perform the coding, spatial prediction relies on blocks within a common frame (other coded unit) to perform the coding. Spatial prediction coding codes intra blocks, while temporal prediction coding codes inter blocks. Again, the spatial prediction components are not shown in FIG. 2 for simplicity. However, the quantization techniques of this disclosure can apply with respect to coefficients that are generated by transformation that follows a spatial prediction coding process.

Following quantization, coefficient encode unit 46 codes the quantized transform coefficients, e.g., according a variable length coding methodology, to even further reduce the bit rate of transmitted information. Following the coding of the transform coefficients, the encoded video may be transmitted to another device. In addition, inverse quantization unit 42 and inverse transform unit 44 apply inverse quantization and inverse transformation, respectively, to reconstruct the residual block. Summer 51 adds the reconstructed residual block to the motion compensated prediction block produced by motion compensation unit 36 to produce a reconstructed video block for storage in reference frame store 34. The reconstructed video block is used by motion estimation unit 32 and motion compensation unit 36 to encode a block in a subsequent video frame.

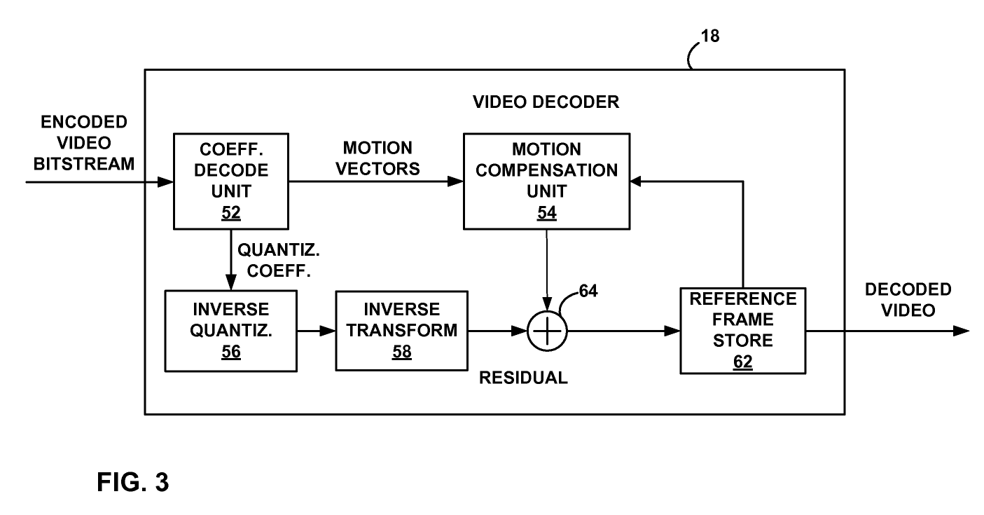

FIG. 3 is a block diagram illustrating an example of a video decoder 18, which may correspond to that of FIG. 1. Video decoder 18 may perform intra- and inter-decoding of blocks within video frames. In the example of FIG. 3, video decoder 18 includes coefficient decode unit 52, motion compensation unit 54, inverse quantization unit 56, inverse transform unit 58, and reference frame store 62. Video decoder 18 also includes summer 64, which combines the outputs of inverse transmit unit 58 and motion compensation unit 54. Optionally, video decoder 18 also may include a deblocking filter (not shown) that filters the output of summer 64. FIG. 3 illustrates the temporal prediction components of video decoder 18 for inter-decoding of video blocks. Although not shown in FIG. 3, video decoder 18 also includes spatial prediction components for intra-decoding of some video blocks. In one example, the various components of video decoder 18 of FIG. 3 may correspond to processor 24 and memory 23 of FIG. 1. For example, reference frame store 62 and any temporary storage elements between the different components (which are not shown in FIG. 3 for simplicity) may be implemented as memory 23, and the other illustrated elements of FIG. 3 may be implemented as processor 24 that executes the functions described below. Furthermore, computer-readable instructions may be stored in memory 23 and executed by processor 24 to carry out the functions described below. As noted, however, many other implementations could be used consistent with this disclosure.

Coefficient decode unit 52 receives the encoded video bitstream and applies variable length decoding techniques, e.g., using a variable length coding table. Following the decoding performed by coefficient decode unit 52, motion compensation unit 54 receives the motion vectors and one or more reconstructed reference frames from reference frame store 62. Inverse quantization unit 56 inverse quantizes, i.e., de-quantizes, the quantized block coefficients. Inverse transform unit 58 applies an inverse transform, e.g., an inverse DCT, to the coefficients to produce residual blocks. Motion compensation unit 54 produces motion compensated blocks that are summed by summer 64 with the residual blocks from inverse transform unit 58 to form decoded blocks. If desired, a deblocking filter may also be applied to filter the decoded blocks in order to remove blockiness artifacts. Block-based video encoding can sometimes result in visually perceivable blockiness at block boundaries of a coded video frame. In such cases, deblock filtering may smooth the block boundaries to reduce or eliminate the visually perceivable blockiness. Following any optional deblock filtering, the filtered blocks are then placed in reference frame store 62, which provides reference blocks from motion compensation and also produces decoded video to a drive display device (such as device 20 of FIG. 1).

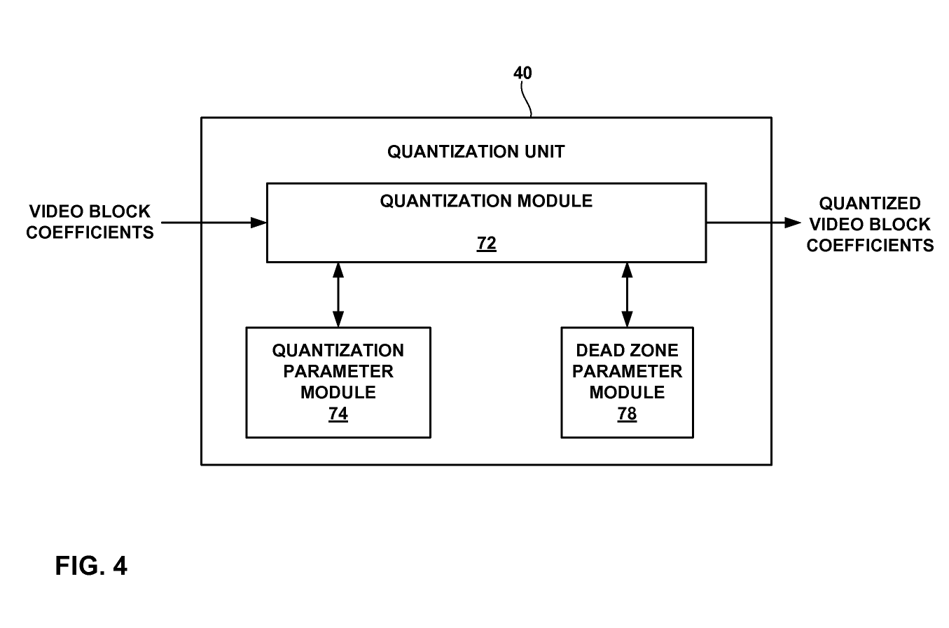

FIG. 4 is a block diagram illustrating an exemplary quantization unit 40, which may correspond to that shown in FIG. 2. Quantization unit 40 includes a quantization module 72, a quantization parameter module 74, and a dead zone parameter module 78. According to this disclosure quantization parameter module 74 selects a quantization parameter for a set of video blocks, dead zone parameter module 78 selects dead zone parameters for different video blocks in the set of video blocks, and quantization module 72 applies the quantization parameter and the dead zone parameters to quantize the coefficient values of each of the video blocks.

In order to quantize the coefficient values of each of the video blocks, quantization module 72 may apply:

$$Z = ⌊ \frac{\vert W \vert + f}{Q} ⌋ ,$$

where Z represents a quantized value, W represents a coefficient value prior to quantization, Q represents the quantization step size corresponding to the quantization parameter, f represents a dead zone parameter and [symbol] is an operand to round to a nearest less than or equal to integer. Quantization parameter module 74 selects a quantization parameter for a set of video blocks, and dead zone parameter module 78 selects dead zone parameters individually for each of the video blocks in the set. Thus, the quantization parameter may be the same for the set of video blocks, but the dead zone parameters may be different for different ones of the video blocks in the set.

The ability to select the quantization parameter for a set of video blocks and separately select dead zone parameters for each of the video blocks (or possibly select multiple dead zone parameters for each of the video blocks) allows more control over the quantization than can be achieved with quantization parameter selection alone.

The set of video blocks may refer to all the video blocks of a given coding unit (e.g., all the video blocks of a video frame or a slice of a frame). In this case, selecting the quantization parameter may comprise selecting the quantization parameter for all of the video blocks of a video frame or slice, selecting the dead zone parameters may comprise selecting different dead zone parameters for different ones of the video blocks within the video frame or slice, and applying the quantization parameter and the dead zone parameters may comprise quantizing the frame or slice.

In this example, quantization module 74 may select different quantization parameters for different video frames or slices. Dead zone parameter module 78 may select different dead zone parameters for different video blocks within each of the video frames or slices, and quantization module 72 can apply the different quantization parameters and the different dead zone parameters to quantize each of the frames of slices.

In another example, the set of video blocks may refer to a 16 by 16 macroblock that itself includes sub-partitions. In this case, quantization module 74 may select the quantization parameter for a 16 by 16 macroblock, wherein the 16 by 16 macroblock includes sub-partitions that define the set of video blocks. Also, in this case, dead zone parameter module 78 may select different dead zone parameters for different ones of the sub-partitions of the 16 by 16 macroblock, and quantization module 72 may apply the quantization parameter and the dead zone parameters to quantize the 16 by 16 macroblock.

In yet another example, the set of video blocks may be defined as all of the video blocks rendered over a defined period of time, such as over a 1 second interval. In some wireless broadcast applications, time intervals of approximately 1 second define so-called “superframes” of data. In this case, selecting the quantization parameter for the set of video blocks may comprise selecting the quantization parameter for all video blocks to be rendered in a defined time interval (e.g., a superframe), selecting the dead zone parameters may comprise selecting different dead zone parameters for different ones of the video blocks to be rendered in the defined time interval, and applying the quantization parameter and the dead zone parameters may comprise quantizing the video blocks to be rendered in the defined time interval. Quantization module 74 selects the quantization parameter, dead zone parameter module 78 selects the different dead zone parameters for different ones of the video blocks to be rendered in the defined time interval, and quantization module 72 applies the quantization parameter and the dead zone parameters to quantize the video blocks to be rendered in the defined time interval.

In some cases, the techniques of this disclosure may be applied for multi-pass video coding. In multi-pass video coding, an initial coding pass is first used to code the video content, e.g., at a first level of quantization. Subsequent coding passes, then, may re-encode the data or refine the coding at different levels of quantization. According to the techniques of this disclosure, the dead zone parameter may be selected or adjusted in one or more of the subsequent coding passes following an initial coding pass. In this case, dead zone parameter module 78 may select or adjust one or more of the dead zone parameters in a subsequent coding pass, and quantization module 72 may apply the quantization parameter and the dead zone parameters, including any of the adjusted dead zone parameters, to re-quantize the coefficient values of each of the video blocks in the subsequent coding pass.

In still other cases, multiple dead zone parameter selections may be performed for one particular video block to provide different levels of quantization within a given video block. For example, dead zone parameter module 78 may select different dead zone parameters for different sets of coefficients within a given video blocks, and quantization module 72 may apply the quantization parameter and the different dead zone parameters to quantize the different sets of coefficients within the given one of the video blocks. This technique may be useful to provide more levels of detail (less quantization) to low frequency components of a video block, and less levels of detail (more quantization) to high frequency components of the video block.

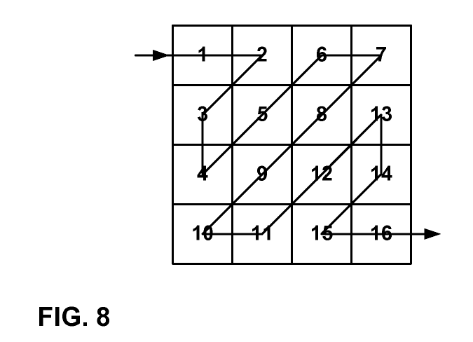

The low frequency components generally refer to the earlier occurring coefficients of a video block in zig-zag scan order. The high frequency components generally refer to the later occurring coefficients of a video block in the zig-zag scan order. For example, a 4 by 4 video block may include 16 coefficients as shown in FIG. 8. In zig-zag scanning, coefficients are typically scanned in a zig-zag order, e.g., from coefficient 1 through coefficient 16 in a zig-zag fashion shown in FIG. 8. The first coefficient in the upper left corner is the lowest frequency components, and is sometimes called the DC component. The highest frequency component is the component in the lower right hand corner of the video block. The first eight components (in zig-zag scan order), such as coefficients 1-8 of FIG. 8, may define the low frequency components, and the last eight components (in zig-zag scan order), such as coefficients 9-16 of FIG. 8, may define the high frequency components. If desired, additional sets may be defined within a video block, and different dead zone parameters may be used for each of the sets of coefficients.

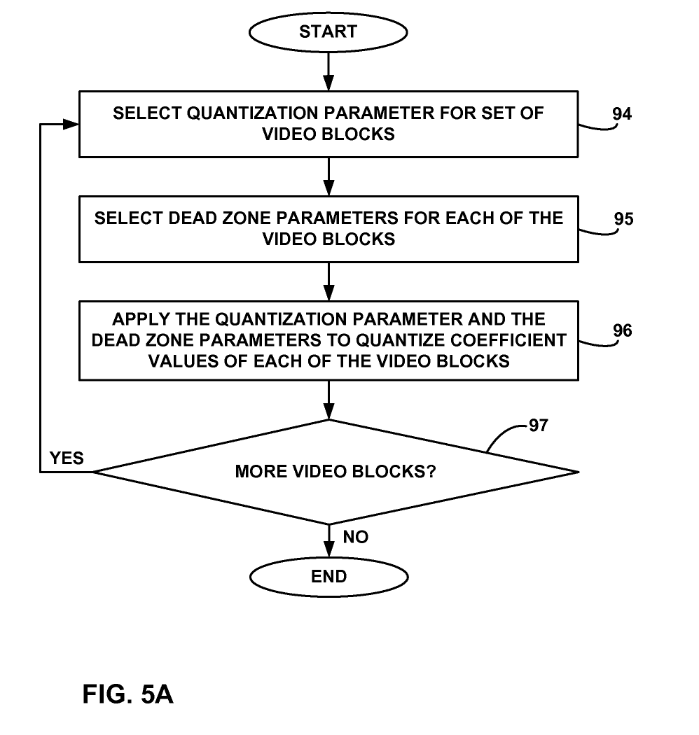

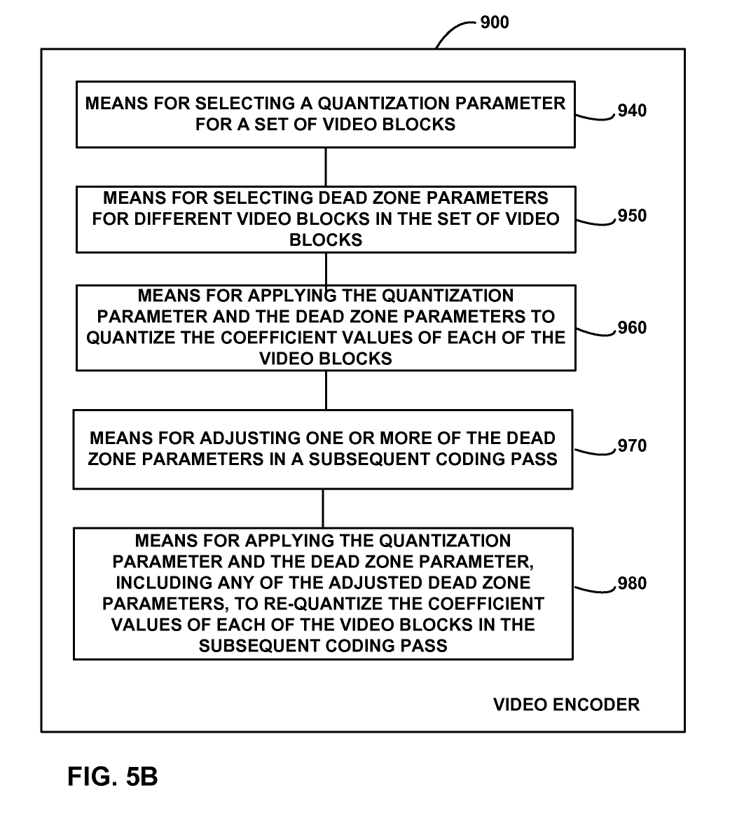

FIG. 5A is a flow diagram illustrating a technique for quantizing coefficient values of video blocks in a video coding scheme. As shown in FIG. 5A, quantization parameter module 74 selects a quantization parameter for a set of video blocks (94). Dead zone parameter module 78 selects dead zone parameters for each of the video blocks (95). Quantization module 72 applies the quantization parameter and the dead zone parameters to quantize coefficient values of each of the video blocks (96). The process of FIG. 5A may repeat whenever there are more video blocks to encode (yes branch of 97).

FIG. 5B is a functional block diagram of a video encoder 900 illustrating structure for implementing the method of FIG. 5A. According to an embodiment of the present invention, video encoder 900 includes means 940 for selecting a quantization parameter for a set of video blocks, means 950 for selecting dead zone parameters for different video blocks in the set of video blocks, and means 960 for applying the quantization parameter and the dead zone parameters to quantize the coefficient values of each of the video blocks. In a subsequent coding pass, one or more of the dead zone parameters may be adjusted. Accordingly, video encoder 900 further includes means 970 for adjusting one or more of the dead zone parameters in a subsequent coding pass, and means 980 for applying the quantization parameter and the dead zone parameters, including any of the adjusted dead zone parameters, to re-quantize the coefficient values of each of the video blocks in the subsequent coding pass.

According to this embodiment, the structure corresponding to the functional blocks may be implemented according to FIGS. 1-4 and the corresponding description set forth above.

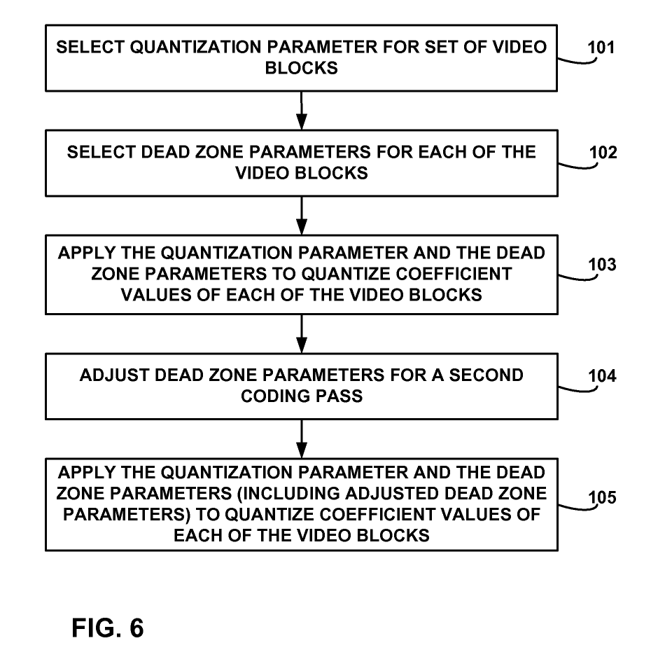

FIG. 6 is a flow diagram illustrating a two-pass coding technique according to this disclosure. As shown in FIG. 6, quantization parameter module 74 selects a quantization parameter for a set of video blocks (101). Dead zone parameter module 78 selects dead zone parameters for each of the video blocks (102). Quantization module 72 applies the quantization parameter and the dead zone parameters to quantize coefficient values of each of the video blocks (103). Dead zone parameter 78 then selects dead zone parameters for a second coding pass (104), e.g., selects different dead zone parameters in order to adjust the level of quantization in the second coding pass. Quantization module 72 applies the quantization parameter and the dead zone parameters (including any of the adjusted dead zone parameter defined in the second coding pass) to quantize coefficient values of each of the video blocks (105). In this manner, a second coding pass can re-quantize the coefficient values to adjust the video coding bit rate defined in the first coding pass. The techniques of this disclosure may be used to target and achieve a particular bit rate or a particular quality level in the video coding. Such results may be achieved in a first coding pass, or in subsequent coding passes using the techniques of this disclosure.

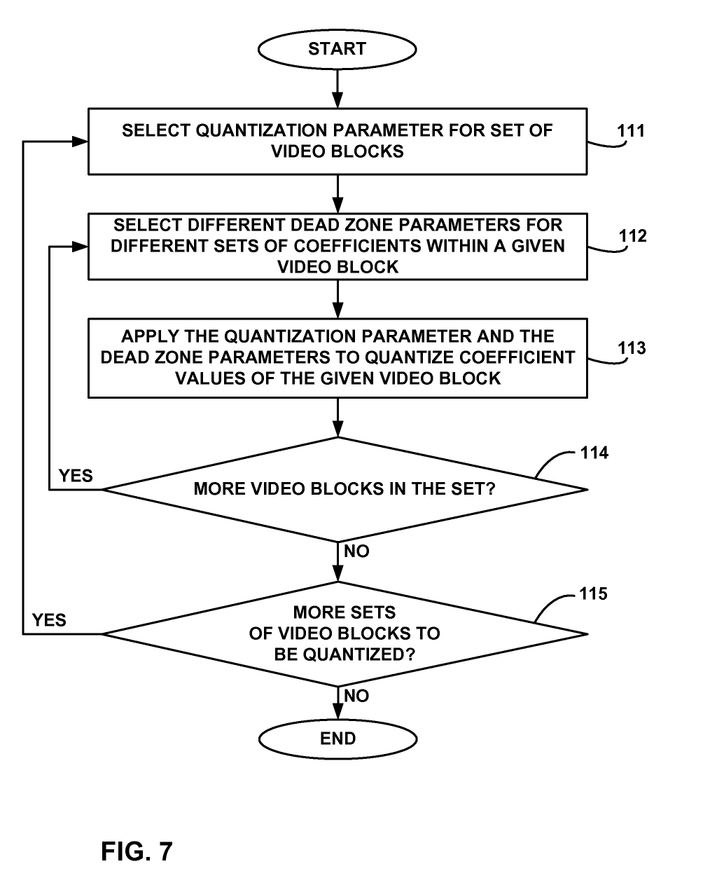

FIG. 7 is a flow diagram illustrating a technique according to this disclosure in which different dead zone parameters are defined within a given video block. As shown in FIG. 7, quantization parameter module 74 selects a quantization parameter for a set of video blocks (111). Dead zone parameter module 78 selects different dead zone parameters for different sets of coefficients within a given video block (112). Quantization module 72 then applies the quantization parameter and the dead zone parameters to quantize coefficient values of the given video block (113). If there are more video blocks in the set of video blocks (yes branch of 114), then dead zone parameter module 78 again selects different dead zone parameters for different sets of coefficients within a given video block (112), quantization module 72 applies the quantization parameter and the dead zone parameters to quantize coefficient values of the given video block (113). The process of steps 112-114 repeats until there are no more video blocks in the set of video blocks (yes branch of 114). At this point, quantization unit 40 determines whether there are more sets of video blocks to be quantized (115). If so (yes branch of 115), the process of FIG. 7 repeats for subsequent sets of video blocks until all of the video blocks are quantized.

In general, larger dead zone parameters result in smaller dead zones, and thus, more non-zero coefficients after the quantization. Smaller dead zone parameters result in larger dead zones, and thus, fewer non-zero coefficients after the quantization. The dead zone parameter selections described above may be driven, at least in part, by these observations. Upward dead zone parameter adjustments may be used to increase the number of bits used in quantizing video blocks, while downward dead zone parameter adjustments may be used to decrease the number of bits used in quantizing video blocks. If desired, a relationship may be defined between dead zone parameter adjustments and corresponding bit rate adjustments that will likely result from the dead zone parameter adjustments.

The techniques described herein may be implemented in hardware, software, firmware, or any combination thereof. Any features described as modules or components may be implemented together in an integrated logic device or separately as discrete but interoperable logic devices. If implemented in software, the techniques may be realized at least in part by a computer-readable medium comprising instructions that, when executed, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules configured for encoding and decoding, or incorporated in a combined video encoder-decoder (CODEC).

Various embodiments of the invention have been described. These and other embodiments are within the scope of the following claims.

1. A method of quantizing coefficient values of video blocks in a video coding scheme comprising:
selecting a quantization parameter for a set of video blocks;
selecting dead zone parameters for different video blocks in the set of video blocks; and
applying the quantization parameter and the dead zone parameters to quantize the coefficient values of each of the video blocks.

2. The method of claim 1, wherein Q represents a quantization step size defined by the selected quantization parameter, f represents a given one of the dead zone parameters, and Q−f defines a dead zone, wherein any of the coefficients values below the dead zone are quantized to 0.

3. The method of claim 1, wherein selecting the dead zone parameters comprises selecting different dead zone parameters for different video blocks in the set of video blocks.

4. The method of claim 1, wherein selecting the quantization parameter, selecting the dead zone parameters and applying the quantization parameter and the dead zone parameters take place in an initial coding pass, the method further comprising:
adjusting one or more of the dead zone parameters in a subsequent coding pass; and
applying the quantization parameter and the dead zone parameters, including any of the adjusted dead zone parameters, to re-quantize the coefficient values of each of the video blocks in the subsequent coding pass.

5. The method of claim 1, wherein:
selecting the quantization parameter comprises selecting the quantization parameter for a macroblock, wherein the macroblock includes sub-partitions that define the set of video blocks;
selecting the dead zone parameters comprises selecting different dead zone parameters for different ones of the sub-partitions of the macroblock; and
applying the quantization parameter and the dead zone parameters comprises quantizing the macroblock.

6. The method of claim 1, wherein:
selecting the quantization parameter comprises selecting the quantization parameter for all of the video blocks of a video frame or slice;
selecting the dead zone parameters comprises selecting different dead zone parameters for different ones of the video blocks within the video frame or slice; and
applying the quantization parameter and the dead zone parameters comprises quantizing the frame or slice based on the quantization parameter and the different dead zone parameters.

7. The method of claim 6, further comprising:
selecting different quantization parameters for different video frames or slices;
selecting different dead zone parameters for different video blocks within each of the video frames or slices; and
applying the different quantization parameters and the different dead zone parameters to quantize each of the frames of slices.

8. The method of claim 1, further comprising:
selecting different dead zone parameters for different sets of coefficients within a given one of the video blocks; and
applying the quantization parameter and the different dead zone parameters to quantize the different sets of coefficients within the given one of the video blocks.

9. The method of claim 1, wherein applying the quantization parameter and the dead zone parameters comprises applying:
$$Z = ⌊ \frac{\vert W \vert + f}{Q} ⌋$$
to quantize the coefficient values, wherein Z represents a given quantized value associated with a given coefficient, W represents a given coefficient value prior to quantization, Q represents a the quantization step size defined by the selected quantization parameter, f represents a given one of the dead zone parameters and [symbol] is an operand to round to a nearest less than or equal to integer.

10. The method of claim 1, wherein applying the quantization parameter and the dead zone parameters to quantize the coefficient values of each of the video blocks comprises controlling an amount of data used to code the video blocks.

11. The method of claim 1, wherein:
selecting the quantization parameter for the set of video blocks comprises selecting the quantization parameter for all video blocks to be rendered in a defined time interval;
selecting the dead zone parameters comprises selecting different dead zone parameters for different ones of the video blocks to be rendered in the defined time interval; and
applying the quantization parameter and the dead zone parameters comprises quantizing the video blocks to be rendered in the defined time interval.

12. The method of claim 11, wherein the defined time interval comprises approximately 1 second of time.

13. An apparatus comprising a quantization unit that quantizes coefficient values of video blocks in a video coding scheme, the quantization unit including:
a quantization parameter module that selects a quantization parameter for a set of video blocks;
a dead zone parameter module that selects dead zone parameters for different video blocks in the set of video blocks; and
a quantization module that applies the quantization parameter and the dead zone parameters to quantize the coefficient values of each of the video blocks.

14. The apparatus of claim 13, wherein Q represents a quantization step size defined by the selected quantization parameter, f represents a given one of the dead zone parameters, and Q−f defines a dead zone, wherein any of the coefficients values below the dead zone are quantized to 0.

15. The apparatus of claim 13, wherein the dead zone parameter module selects different dead zone parameters for different video blocks in the set of video blocks.

16. The apparatus of claim 13, wherein selecting the quantization parameter, selecting the dead zone parameters and applying the quantization parameter and the dead zone parameters take place in an initial coding pass, and wherein:
the dead zone parameter module adjusts one or more of the dead zone parameters in a subsequent coding pass; and
the quantization module applies the quantization parameter and the dead zone parameters, including any of the adjusted dead zone parameters, to re-quantize the coefficient values of each of the video blocks in the subsequent coding pass.

17. The apparatus of claim 13, wherein:
the quantization parameter module selects the quantization parameter for a macroblock, wherein the macroblock includes sub-partitions that define the set of video blocks;
the dead zone parameter module selects different dead zone parameters for different ones of the sub-partitions of the macroblock; and
the quantization module applies the quantization parameter and the dead zone parameters to quantize the macroblock.

18. The apparatus of claim 13, wherein:
the quantization parameter module selects the quantization parameter for all of the video blocks of a video frame or slice;
the dead zone parameter module selects different dead zone parameters for different ones of the video blocks within the video frame or slice; and
the quantization module applies the quantization parameter and the dead zone parameters to quantize the frame or slice based on the quantization parameter and the different dead zone parameters.

19. The apparatus of claim 18, further wherein:
the quantization parameter module selects different quantization parameters for different video frames or slices;
the dead zone parameter module selects different dead zone parameters for different video blocks within each of the video frames or slices;
the quantization module applies the different quantization parameters and the different dead zone parameters to quantize each of the frames of slices.

20. The apparatus of claim 13, further wherein:
the dead zone parameter module selects different dead zone parameters for different sets of coefficients within a given one of the video blocks; and
the quantization module applies the quantization parameter and the different dead zone parameters to quantize the different sets of coefficients within the given one of the video blocks.

21. The apparatus of claim 13, wherein to quantize the coefficient values of each of the video blocks, the quantization module applies:
$$Z = ⌊ \frac{\vert W \vert + f}{Q} ⌋ ,$$
wherein Z represents a given quantized value associated with a given coefficient, W represents a given coefficient value prior to quantization, Q represents a quantization step size defined by the selected quantization parameter, f represents a given one of the dead zone parameters and [symbol] is an operand to round to a nearest less than or equal to integer.

22. The apparatus of claim 13, wherein the quantization module that applies the quantization parameter and the dead zone parameters to control an amount of data used to code the video blocks.

23. The apparatus of claim 13, wherein:
the quantization parameter module selects the quantization parameter for all video blocks to be rendered in a defined time interval;
the dead zone parameter module selects different dead zone parameters for different ones of the video blocks to be rendered in the defined time interval; and
the quantization module applies the quantization parameter and the dead zone parameters to quantize the video blocks to be rendered in the defined time interval.

24. The apparatus of claim 23, wherein the defined time interval comprises approximately 1 second of time.

25. A computer-readable medium comprising instructions that upon execution in a processor cause the processor to:
select a quantization parameter for a set of video blocks;
select dead zone parameters for different video blocks in the set of video blocks; and
apply the quantization parameter and the dead zone parameters to quantize coefficient values of each of the video blocks.

26. The computer-readable medium of claim 25, wherein Q represents a quantization step size defined by the selected quantization parameter, f represents a given one of the dead zone parameters, and Q−f defines a dead zone, wherein any of the coefficients values below the dead zone are quantized to 0.

27. The computer-readable medium of claim 25, wherein the instructions upon execution cause the processor to select different dead zone parameters for different video blocks in the set of video blocks.

28. The computer-readable medium of claim 25, wherein selecting the quantization parameter, selecting the dead zone parameters and applying the quantization parameter and the dead zone parameters take place in an initial coding pass, and wherein the instructions upon execution cause the processor to:
adjust one or more of the dead zone parameters in a subsequent coding pass; and
apply the quantization parameter and the dead zone parameters, including any of the adjusted dead zone parameters, to re-quantize the coefficient values of each of the video blocks in the subsequent coding pass.

29. The computer-readable medium of claim 25, wherein the instructions upon execution cause the processor to:
select the quantization parameter comprises selecting the quantization parameter for a macroblock, wherein the macroblock includes sub-partitions that define the set of video blocks;
select the dead zone parameters comprises selecting different dead zone parameters for different ones of the sub-partitions of the macroblock; and
apply the quantization parameter and the dead zone parameters comprises quantizing the macroblock.

30. The computer-readable medium of claim 25, wherein the instructions upon execution cause the processor to:
select the quantization parameter for all of the video blocks of a video frame or slice;
select different dead zone parameters for different ones of the video blocks within the video frame or slice; and
apply the quantization parameter and the dead zone parameters to quantize the frame or slice based on the quantization parameter and the different dead zone parameters.

31. The computer-readable medium of claim 30, wherein the instructions upon execution cause the processor to:
select different quantization parameters for different video frames or slices;
select different dead zone parameters for different video blocks within each of the video frames or slices; and
apply the different quantization parameters and the different dead zone parameters to quantize each of the frames of slices.

32. The computer-readable medium of claim 25, wherein the instructions upon execution cause the processor to:
select different dead zone parameters for different sets of coefficients within a given one of the video blocks; and
apply the quantization parameter and the different dead zone parameters to quantize the different sets of coefficients within the given one of the video blocks.

33. The computer-readable medium of claim 25, wherein to quantize the coefficient values of each of the video blocks, the instructions upon execution cause the processor to apply:
$$Z = ⌊ \frac{\vert W \vert + f}{Q} ⌋ ,$$
wherein Z represents a given quantized value, W represents a given coefficient value prior to quantization, Q represents a quantization step size defined by the selected quantization parameter, f represents a given one of the dead zone parameters and [symbol] is an operand to round to a nearest less than or equal to integer.

34. The computer-readable medium of claim 25, wherein the instructions upon execution cause the processor to apply the quantization parameter and the dead zone parameters to control an amount of data used to code the video blocks.

35. The computer-readable medium of claim 25, wherein the instructions upon execution cause the processor to:
select the quantization parameter for all video blocks to be rendered in a defined time interval;
select different dead zone parameters for different ones of the video blocks to be rendered in the defined time interval; and
apply the quantization parameter and the dead zone parameters to quantize the video blocks to be rendered in the defined time interval.

36. The computer-readable medium of claim 35, wherein the defined time interval comprises approximately 1 second of time.

37. A device that quantizes coefficient values of video blocks in a video coding scheme, the device comprising:
means for selecting a quantization parameter for a set of video blocks;
means for selecting dead zone parameters for different video blocks in the set of video blocks; and
means for applying the quantization parameter and the dead zone parameters to quantize the coefficient values of each of the video blocks.

38. The device of claim 37, wherein Q represents a quantization step size defined by the selected quantization parameter, f represents a given one of the dead zone parameters, and Q−f defines a dead zone, wherein any of the coefficients values below the dead zone are quantized to 0.

39. The device of claim 37, wherein means for selecting the dead zone parameters comprises means for selecting different dead zone parameters for different video blocks in the set of video blocks.

40. The device of claim 37, wherein selecting the quantization parameter, selecting the dead zone parameters and applying the quantization parameter and the dead zone parameters take place in an initial coding pass, the device further comprising:
means for adjusting one or more of the dead zone parameters in a subsequent coding pass; and
means for applying the quantization parameter and the dead zone parameters, including any of the adjusted dead zone parameters, to re-quantize the coefficient values of each of the video blocks in the subsequent coding pass.

41. The device of claim 37, wherein:
means for selecting the quantization parameter comprises means for selecting the quantization parameter for a macroblock, wherein the macroblock includes sub-partitions that define the set of video blocks;
means for selecting the dead zone parameters comprises means for selecting different dead zone parameters for different ones of the sub-partitions of the macroblock; and
means for applying the quantization parameter and the dead zone parameters comprises means for quantizing the macroblock.

42. The device of claim 37, wherein:
means for selecting the quantization parameter comprises means for selecting the quantization parameter for all of the video blocks of a video frame or slice;
means for selecting the dead zone parameters comprises means for selecting different dead zone parameters for different ones of the video blocks within the video frame or slice; and
means for applying the quantization parameter and the dead zone parameters comprises means for quantizing the frame or slice based on the quantization parameter and the different dead zone parameters.

43. The device of claim 42, further wherein:
means for selecting quantization parameters selects different quantization parameters for different video frames or slices;
means for selecting dead zone parameters selects different dead zone parameters for different video blocks within each of the video frames or slices; and
means for applying the different quantization parameters and the different dead zone parameters quantizes each of the frames of slices.

44. The device of claim 37, further wherein:
means for selecting dead zone parameters selects different dead zone parameters for different sets of coefficients within a given one of the video blocks; and
means for applying the different quantization parameters and the different dead zone parameters quantizes the different sets of coefficients within the given one of the video blocks.

45. The device of claim 37, wherein means for applying the quantization parameter and the dead zone parameters applies:
$$Z = ⌊ \frac{\vert W \vert + f}{Q} ⌋$$
to quantize the coefficient values, wherein Z represents a given quantized value associated with a given coefficient, W represents a given coefficient value prior to quantization, Q represents a quantization step size defined by the selected quantization parameter, f represents a given one of the dead zone parameters and [symbol] is an operand to round to a nearest less than or equal to integer.

46. The device of claim 37, wherein means for applying applies the quantization parameter and the dead zone parameters to control an amount of data used to code the video blocks.

47. The device of claim 37, wherein:
means for selecting the quantization parameter for the set of video blocks comprises means for selecting the quantization parameter for all video blocks to be rendered in a defined time interval;
means for selecting the dead zone parameters comprises means for selecting different dead zone parameters for different ones of the video blocks to be rendered in the defined time interval; and
means for applying the quantization parameter and the dead zone parameters comprises means for quantizing the video blocks to be rendered in the defined time interval.

48. The device of claim 47, wherein the defined time interval comprises approximately 1 second of time.
